(19) United States
(12) Patent Application Publication
(10) Pub. No.: US 2015/0192678 A1
(43) Pub. Date: Jul. 9, 2015

(54) SATELLITE POSITIONING METHOD, SATELLITE POSITIONING APPARATUS, AND COMPUTER-READABLE MEDIUM

(71) Applicant: INDUSTRIAL TECHNOLOGY RESEARCH INSTITUTE, Hsinchu (TW)

(72) Inventors: Chun-I CHU, Hsinchu County (TW); Feng-Chang KUO, Hsinchu (TW); Chen-Ying KAO, Taoyuan County (TW); He-Sheng WANG, Keelung (TW); Jing-Fen CHEN, Taipei (TW)

(73) Assignee: INDUSTRIAL TECHNOLOGY RESEARCH INSTITUTE, Hsinchu (TW)

(21) Appl. No.: 14/244,680

(22) Filed: Apr. 3, 2014

(30) Foreign Application Priority Data
Jan. 3, 2014 (TW) 103100253

(51) Int. Cl. G01S 19/01

(52) U.S. Cl. CPC G01S 19/01

(57) ABSTRACT

Disclosed herein are a method and an apparatus of satellite positioning, the apparatus comprising a receiver module, a phase-difference measurement module, an angle-of-arrival calculation module, and a positioning module. The receiver module receives at a locale a first and a second signal from a satellite. The phase-difference measurement module measures the frequency of a phase difference of the signals along a geographic direction. The angle-of-arrival calculation module calculates the cosine of an angle of arrival of the signals for the geographic direction based on the frequency of the phase difference, the frequency difference of the signals, and a travelling speed of the satellite along that geographic direction. The positioning module calculates the coordinate of the locale along the geographic direction in the three-dimensional space based on that of the satellite, a distance between the satellite and the locale, and the cosine of the angle of arrival.

### CROSS-REFERENCE TO RELATED APPLICATIONS

This non-provisional application claims priority under 35 U.S.C. §119(a) on Patent Application No. 103100253 filed in Taiwan, R.O.C. on Jan. 3, 2014, the entire contents of which are hereby incorporated by reference.

### TECHNICAL FIELD

This disclosure relates to a method and an apparatus for positioning with the dual-band signals of a single satellite by calculating angles of arrival.

### BACKGROUND

In satellite navigation, such as with the Global Positioning System (GPS), at least four satellites are required to be visible for a receiver to accurately determine its own position. Signals from the satellites, however, are often severely attenuated in urban environments, rendering regular positioning impossible. A common remedy is to prepare assistive information in cellular networks (GSM, CDMA2000, Long Term Evolution, etc) or wireless local area networks, an endeavor calling for the implementation of the hardware and protocol of these networks at the receiving end as well as the cooperation of operators and manufacturers. The reality is that with so many communication standards, satellite navigation is becoming less of the public service it was intended and more of a technical tribulation incurring significant social costs.

### SUMMARY

In light of the above, the exemplary embodiments disclose a satellite positioning method, a satellite positioning apparatus, and a computer-readable medium, wherein single-satellite positioning is attained by calculating angles of arrival of the satellite's inherent dual-band signals for two geographic directions.

In the satellite positioning method provided by this disclosure, a first signal and a second signal broadcast by a satellite in a first frequency and a second frequency, respectively, are received at a locale. The frequency of a phase difference between the signals along a geographic direction is measured, and the cosine of an angle of arrival of the signals for the geographic direction is calculated based on the frequency of the phase difference, the difference of the frequencies, and a travelling speed of the satellite relative to the locale along the geographic direction. Finally, the coordinate of the locale along the geographic direction in the three-dimensional space is calculated based on the coordinate of the satellite along the geographic direction in the three-dimensional space, a distance between the satellite and the locale, and the cosine of the angle of arrival.

The satellite positioning apparatus provided by this disclosure comprises a receiver module, a phase-difference measurement module, an angle-of-arrival calculation module, and a positioning module. The receiver module is adapted for receiving at a locale a first and a second signal broadcast by a satellite in a first frequency and a second frequency, respectively. The phase-difference measurement module, couple with the receiver module, is adapted for measuring the frequency of a phase difference of the signals along a geographic direction. The angle-of-arrival calculation module, coupled with the phase-difference measurement module, is adapted for calculating the cosine of an angle of arrival of the signals for the geographic direction based on the frequency of the phase difference, the difference of the frequencies, and a travelling speed of the satellite along the geographic direction. The positioning module, coupled with the angle-of-arrival calculation module, is adapted for calculating the coordinate of the locale along the geographic direction in the three-dimensional space based on the coordinate of the satellite along the geographic direction in the three-dimensional space, a distance between the satellite and the locale, and the cosine of the angle of arrival.

The computer-readable medium provided by this disclosure contains computer program code for causing a processor to perform instructions. The instructions comprises calculating for a geographic direction the cosine of an angle of arrival of a first and a second signal broadcast by the satellite respectively in a first frequency and a second frequency, based on the frequency of a phase difference between the signals along the geographic direction, the difference of the frequencies, and a travelling speed of a satellite relative to a locale along the geographic direction, and calculating the coordinate of the locale along the geographic direction in the three-dimensional space, based on the coordinate of the satellite along the geographic direction in the three-dimensional space, a distance between the satellite and the locale, and the cosine of the angle of arrival.

In short, the exemplary embodiments calculate the angles of arrival of the dual-band signals using the frequency difference, the travelling speed of the satellite, and the frequencies of the phase difference of the signals, and then derive the coordinates of the locale from those of the satellite, the angles of arrival, and the distance between the locale and the satellite. The frequency difference and the satellite's distance, coordinates, and travelling speed are available from the contents of the signals, whereas the calculations may be implemented in software or hardware.

### BRIEF DESCRIPTION OF THE DRAWING

The exemplary embodiments will become more fully understood from the detailed description given hereinbelow and the accompanying drawings which are given by way of illustration only and thus are not limitative of the exemplary embodiments and wherein:

FIG. 1 is a diagram of a satellite and a locale in the three-dimensional space.

FIG. 2 is a high-level block diagram of a satellite positioning apparatus, in accordance with one of the exemplary embodiments.

FIG. 3 is a flowchart of a satellite positioning method, in accordance with one of the exemplary embodiments.

### DETAILED DESCRIPTION

In the following detailed description, for purposes of explanation, numerous specific details are set forth in order to provide a thorough understanding of the disclosed embodiments. It will be apparent, however, that one or more exemplary embodiments may be practiced without these specific details. In other instances, well-known structures and devices are schematically shown in order to simplify the drawings.

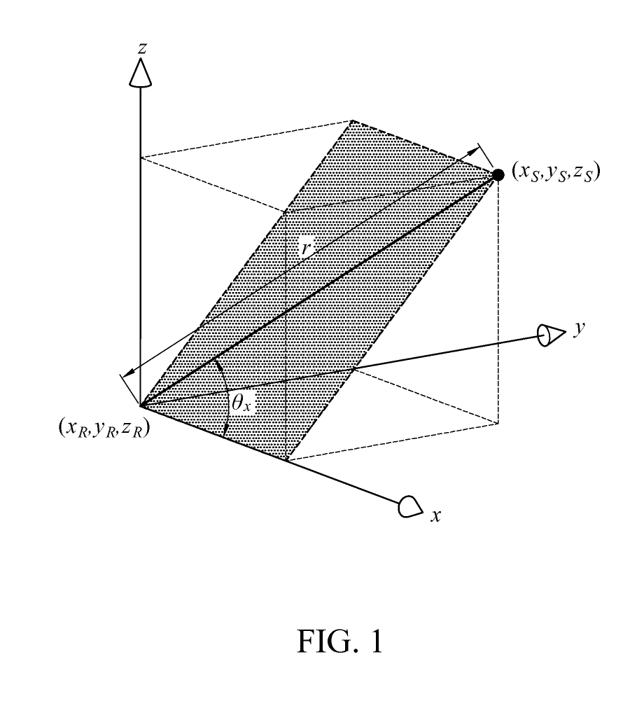

Please refer to FIG. 1. As shown in the diagram, a satellite with the three-dimensional coordinates (x_{S}, y_{S}, z_{S}) and a locale at (x_{R}, y_{R}, z_{R}) are distanced from each other by r={square root over ((x_{S}−x_{R}²+(y_{S}−y_{R})²+(z_{S}−z_{R})²)}. The coordinates, not necessarily Cartesian, may be converted with geodetic data such as the WGS 84 (World Geodetic System 1984). The satellite may be a member of the Global Positioning System (GPS), the French DORIS, the Russian GLONASS, the Japanese Quasi-Zenith Satellite System (QZSS), the Indian Regional Navigational Satellite System (IRNSS), Beidou of China, or Galileo of the European Union, capable of broadcasting signals in two or more frequencies, such as the L1 (1575.42 MHz) and L2C (1227.6 MHz) bands of the GPS, or the L1OF (centered at 1602 MHz), L2OF (centered at 1246 MHz), and L3OC (1202.25 MHz) bands of the GLONASS. The signals may be multiplexed using frequency division or code division.

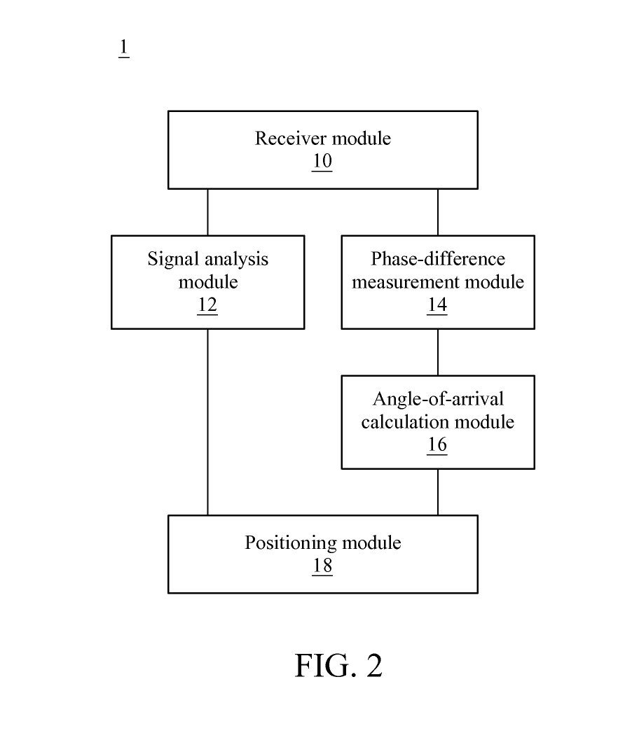

Please refer to FIG. 2 with regard to FIG. 1. As shown in the block diagram, a satellite positioning apparatus 1 comprises a receiver module 10 disposed at the locale, a signal analysis module 12, a phase-difference measurement module 14, an angle-of-arrival calculation module 16, and a positioning module 18. The receiver module 10 may be an antenna or an array of antennae for picking up, say, a GPS signal. The signal would contain an ephemeris which describes the exact orbit of the transmitting satellite and whereby the signal analysis module 12 obtains (x_{S}, y_{S}, z_{S}), and also a timecode representing at what point of time the signal was sent. By multiplying the time difference between the signal's transmission and reception by the speed of light, the signal analysis module 12 is able to estimate the distance r between the satellite and the locale without the knowledge of (x_{R}, y_{R}, z_{R}). An estimated r is termed a pseudorange.

The signal's propagation path, of length r, from the satellite to the locale forms a plane with each of the three spatial coordinate axes. The shaded area in FIG. 1 is one such plane containing the path and the x-axis, and on which the angle between them, θₓ, is the angle of arrival of the signal along the x-axis. By elementary geometry, x_{S}−x_{R}=rAₓ, where Aₓ=cos θₓ, hence

x_{R}=x_{S}−rAₓ

is the coordinate of the locale on the x-axis. Similarly, y_{R}=y_{S}−rA_{y}, where A_{y} is the cosine of the angle of arrival of the signal along the y-axis, and z_{R}=z_{S}−r\sqrt{1−Aₓ²−A_{y}²}.

Two angles of arrival along two directions suffice to calculate the three-dimensional coordinates of the locale in the exemplary embodiments. Take the x-axis as an example. By calculating successive coordinates of the satellite with the orbital information from the signal incessantly received by the receiver module 10, the signal analysis module 12 learns the satellite's travelling speed vₓ, relative to the locale along the x-axis. A pair of dual-band signals s₁(t) and s₂(t), observed with the Doppler effect by the receiver module 10, may be expressed in complex analysis as

$$\{ \begin{matrix}{s}_{1} ( t ) = exp [ i 2 π ( {f}_{1} + {d}_{1} ) t ] + {n}_{1} ( t ) \\ {s}_{2} ( t ) = exp [ i 2 π ( {f}_{2} + {d}_{2} ) t ] + {n}_{2} ( t )\end{matrix} ,$$

where f₁ and f₂ are respectively the broadcast frequencies of the signals s₁(t) and s₂(t), d₁ and d₂ their respective Doppler shift, and n₁(t) and n₂(t) noises, due to whose existence are two signals necessary for positioning. In practice, an algorithm such as MUSIC (Multiple Signal Classifier) or ESPRIT (Estimation of Signal Parameters via Rotational Invariance Technique) may be employed to isolate noise from a plurality of signals, resulting in more reliable s₁(t) and s₂(t). The component of vₓ along the propagation path of the signal on the aforesaid plane is vₓAₓ, hence

$${d}_{1} = \frac{{v}_{x} {A}_{x}}{c} {f}_{1} and$$

$${d}_{2} = \frac{{v}_{x} {A}_{x}}{c} {f}_{2} ,$$

where c is the speed of light. Let Δf=f₂−f₁ and ignore the noises, then

$${s}_{2} ( t ) = {s}_{1} ( t ) \cdot exp [ i 2 π Δ f ( 1 + \frac{{v}_{x} {A}_{x}}{c} ) t ] ,$$

where the multiplier with the exponential function can be seen as another signal, whereby the phase-difference measurement module 14 measures the frequency of the phase difference between s₁(t) and s₂(t) along the x-axis as

$${F}_{x} = Δ f ( 1 + \frac{{v}_{x} {A}_{x}}{c} ) .$$

With Fₓ, Δf, vₓ, and the speed of light in hand and based on

$${A}_{x} = ( \frac{{F}_{x}}{Δ f} - 1 ) \frac{c}{{v}_{x}} ,$$

the angle-of-arrival calculation module 16 obtains the cosine of the angle of arrival of the dual-band signals for the x-axis.

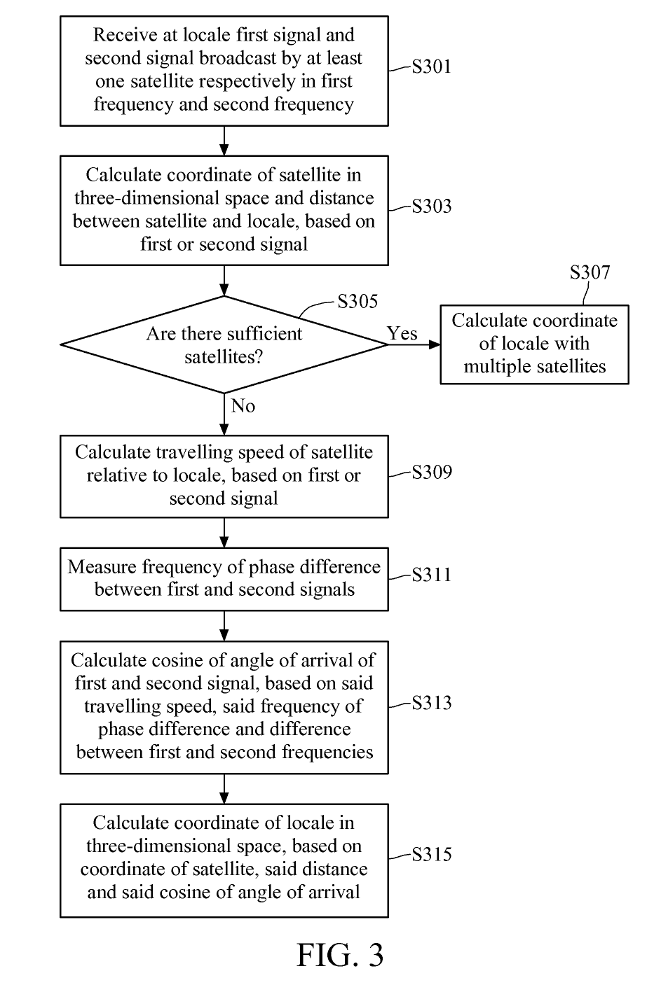

Please refer to FIG. 3 with regard to FIG. 2. As shown in the flowchart, in step S301 the receiver module 10 receives at a locale a first signal and a second signal broadcast by at least one satellite in a first frequency and a second frequency, respectively. In step S303, based on the first or second signal, the signal analysis module 12 calculates the coordinate of the satellite along a geographic direction in the three-dimensional space and the distance between the satellite and the locale. In step S305, the signal analysis module 12 determines whether there are a sufficient number of visible satellites. Assume that there are two modes of positioning for the satellite positioning apparatus 1. The regular one is carried out in step S307 when there are at least four satellites visible, or the apparatus 1 proceeds to step S309 and beyond to position the locale with the single satellite. Alternatively, if exactly two or three satellites were visible, the satellite positioning apparatus 1 may selectively use signals from some of them when it has more than two positioning modes. In step S309, the signal analysis module 12, continuing with step S303, calculates a travelling speed of the satellite relative to the locale along that geographic direction. In step S311, the phase-difference measurement module 14 measures the frequency of a phase difference between the signals along the geographic direction. In step S313, the angle-of-arrival calculation module 16 calculates the cosine of an angle of arrival of the signals, based on the said travelling speed, the said frequency of the phase difference, and the difference between the first and second frequencies. In step S315, the positioning module 18 calculates the coordinate of the locale along that geographic direction in the three-dimensional space, based on the said cosine of the angle of arrival, the coordinate of the satellite, and its distance to the locale. Please note that the algorithm for isolating noise might not converge in practice, necessitating iterative executions of part of steps S311 through S315.

In one embodiment, the angle-of-arrival calculation module 16 and the positioning module 18 (corresponding to steps S313 and S315) may be separately implemented in software or hardware. The positioning is thus performed offline, acquiring from without the frequency difference, the frequency of the phase difference, and the satellite's coordinate, travelling speed, and distance to the locale.

To summarize, the exemplary embodiments deduce the coordinates, travelling speed, and pseudorange of a satellite of a regional or global navigation system from the satellite's existing dual-band signals, and, by measuring the frequency of phase differences between the signals and calculating angles of arrival of the signals for two geographic directions, identify the coordinates of a locale with the sole satellite.

What is claimed is:

1. A satellite positioning method comprising:
receiving a first signal and a second signal at a locale, the first signal being broadcast in a first frequency by a satellite, the second signal being broadcast in a second frequency by the satellite, the first frequency and the second frequency having a frequency difference;
measuring the frequency of a phase difference between the first signal and the second signal along a geographic direction;
calculating the cosine of an angle of arrival of the first signal and the second signal for the geographic direction, based on the frequency of the phase difference, the frequency difference, and a travelling speed of the satellite relative to the locale along the geographic direction; and
calculating the coordinate of the locale along the geographic direction in the three-dimensional space, based on the coordinate of the satellite along the geographic direction in the three-dimensional space, a distance between the satellite and the locale, and the cosine of the angle of arrival.

2. The satellite positioning method of claim 1, wherein calculating the cosine of the angle of arrival is based on a first expression, the first expression being:
$$A = ( \frac{F}{Δ f} - 1 ) \frac{c}{v} ;$$
wherein A is the cosine of the angle of arrival, F is the frequency of the phase difference, Δf is the frequency difference, c is the speed of light, and v is the travelling speed.

3. The satellite positioning method of claim 1, wherein calculating the coordinate of the locale along the geographic direction in the three-dimensional space is based on a second expression, the second expression being:
w_{R}=w_{S}−rA;
wherein w_{R} is the coordinate of the locale along the geographic direction in the three-dimensional space, w_{S} is the coordinate of the satellite along the geographic direction in the three-dimensional space, r is the distance, and A is the cosine of the angle of arrival.

4. The satellite positioning method of claim 1, further comprising:
calculating the travelling speed, the distance, and the coordinate of the satellite along the geographic direction in the three-dimensional space, based on the first signal or the second signal.

5. The satellite positioning method of claim 4 wherein the distance is a pseudorange.

6. A satellite positioning apparatus comprising:
a receiver module for receiving a first signal and a second signal at a locale, the first signal being broadcast in a first frequency by a satellite, the second signal being broadcast in a second frequency by the satellite, the first frequency and the second frequency having a frequency difference;
a phase-difference measurement module coupled with the receiver module and for measuring the frequency of a phase difference between the first signal and the second signal along a geographic direction;
an angle-of-arrival calculation module coupled with the phase-difference measurement module and for calculating the cosine of an angle of arrival of the first signal and the second signal for the geographic direction, based on the frequency of the phase difference, the frequency difference, and a travelling speed of the satellite relative to the locale along the geographic direction; and
a positioning module coupled with the angle-of-arrival calculation module and for calculating the coordinate of the locale along the geographic direction in the three-dimensional space, based on the coordinate of the satellite along the geographic direction in the three-dimensional space, a distance between the satellite and the locale, and the cosine of the angle of arrival.

7. The satellite positioning apparatus of claim 6, wherein the angle-of-arrival calculation module calculating the cosine of the angle of arrival is based on a first expression, the first expression being:
$$A = ( \frac{F}{Δ f} - 1 ) \frac{c}{v} ;$$
wherein A is the cosine of the angle of arrival, F is the frequency of the phase difference, Δf is the frequency difference, c is the speed of light, and v is the travelling speed.

8. The satellite positioning apparatus of claim 6, wherein the positioning module calculating the coordinate of the locale along the geographic direction in the three-dimensional space is based on a second expression, the second expression being:
w_{R}=w_{S}−rA;
wherein w_{R} is the coordinate of the locale along the geographic direction in the three-dimensional space, w_{S} is the coordinate of the satellite along the geographic direction in the three-dimensional space, r is the distance, and A is the cosine of the angle of arrival.

9. The satellite positioning apparatus of claim 6, further comprising:
a signal analysis module coupled with the receiver module and the positioning module and for calculating the travelling speed, the distance, and the coordinate of the satellite along the geographic direction in the three-dimensional space, based on the first signal or the second signal.

10. The satellite positioning apparatus of claim 9, wherein the distance is a pseudorange.

11. A computer-readable medium containing computer program code for causing a processor to perform instructions, the instructions comprising:
calculating the cosine of an angle of arrival of a first signal and a second signal for a geographic direction, based on the frequency of a phase difference between the first signal and the second signal along the geographic direction, a frequency difference, and a travelling speed of a satellite relative to a locale along the geographic direction, the first signal being broadcast in a first frequency by the satellite, the second signal being broadcast in a second frequency by the satellite, the first frequency and the second frequency having the frequency difference; and
calculating the coordinate of the locale along the geographic direction in the three-dimensional space, based on the coordinate of the satellite along the geographic direction in the three-dimensional space, a distance between the satellite and the locale, and the cosine of the angle of arrival.

12. The computer-readable medium of claim 11, wherein calculating the cosine of the angle of arrival is based on a first expression, the first expression being:
$$A = ( \frac{F}{Δ f} - 1 ) \frac{c}{v} ;$$
wherein A is the cosine of the angle of arrival, F is the frequency of the phase difference, Δf is the frequency difference, c is the speed of light, and v is the travelling speed.

13. The computer-readable medium of claim 11, wherein calculating the coordinate of the locale along the geographic direction in the three-dimensional space is based on a second expression, the second expression being:
w_{R}=w_{S}−rA;
wherein w_{R} is the coordinate of the locale along the geographic direction in the three-dimensional space, w_{S} is the coordinate of the satellite along the geographic direction in the three-dimensional space, r is the distance, and A is the cosine of the angle of arrival.
